(19) United States
(12) Patent Application Publication
(10) Pub. No.: US 2018/0251597 A1
(43) Pub. Date: Sep. 6, 2018

(54) COPOLYMER BASED ON DIMETHYL CARBONATE AND METHOD OF PREPARING THE SAME

(71) Applicant: NATIONAL CHENG KUNG UNIVERSITY, Tainan City (TW)

(72) Inventors: CHUH-YUNG CHEN, Tainan city (TW); CHENG-CHIEN WANG, Tainan city (TW); CHI-YUAN HUNG, Tainan city (TW); HSIN YU, Tainan city (TW)

(21) Appl. No.: 15/971,251

(22) Filed: May 4, 2018

Related U.S. Application Data
(63) Continuation-in-part of application No. 14/491,614, filed on Sep. 19, 2014.

(30) Foreign Application Priority Data
Aug. 29, 2014 (TW) 103129944

(51) Int. Cl. C08G 64/30; C08G 64/38

(52) U.S. Cl. CPC C08G 64/305; C08G 64/38

(57) ABSTRACT

A copolymer based on dimethyl carbonate and a method of preparing the same are provided. The copolymer based on dimethyl carbonate has a unit from dimethyl carbonate, diols, and a modification monomer. The copolymer based on dimethyl carbonate can be obtained by proceeding transesterification and polycondenastion.

### CROSS REFERENCE TO RELATED APPLICATIONS

This application is a continuation-in-part application of U.S. patent application Ser. No. 14/491,614, filed on Sep. 19, 2014, which claims the priority of Taiwan Patent Application No. 103129944, filed on Aug. 29, 2014, and the disclosure of which is incorporated herein by reference.

### FIELD OF THE INVENTION

The present invention relates to a copolymer and a method of preparing the copolymer, and more particularly to a copolymer prepared by a dimethyl carbonate and a method of preparing the same.

### BACKGROUND OF THE INVENTION

Polycarbonates (PC) have good biocompatibility and stability, so that polyesters, polyethers, and other polymers used in the biomedical field have been gradually replaced by PC. In addition, aliphatic polycarbonates have excellent weather resistance and material stability, such that they are highly valued by the industrial countries.

The polycarbonate has a very wide range of applications, such as packaging materials, gas barrier materials, toughening agents for brittle materials and adhesions, etc., and has a considerable economic benefit. Aliphatic polycarbonate has good biodegradable properties, when being used to produce plastic bags or other commonly consumed materials; the disadvantages of the traditional polyolefin packaging materials which cannot be degraded in nature and cause environmental pollution will be effectively improved. Regarding the gas barrier material, one of the features of aliphatic polycarbonate is that it has a high gas barrier rate. If aliphatic polycarbonate is added to the polyolefin-based plastic, the barrier rate of gas and water vapor of the polyolefin-based plastic can be improved to be applied to the wrap film or other goods. As for being a toughening agent for a brittle material and an adhesive, aliphatic polycarbonate oligomer with a low molecular weight has excellent viscoelasticity. Since the glass transition temperature (T_{g}) of aliphatic polycarbonate oligomer is below room temperature, it has a certain degree of fluidity and viscosity and can be used as a toughening agent for a brittle material such as epoxy resin and polylactic acid. Recently, there is also an application as an adhesive agent with laminated safety glass.

The traditional synthesis method of polycarbonates is the phosgene method, although highly reactive, phosgene is strongly toxic, and too many toxic solvents are used during the manufacturing process. Furthermore, the use of phosgene is difficult and complex so that the risk of the operation and the cost of the material due to corrosion are increased. In addition, the raw material is limited to only certain aliphatic alcohols, and therefore the phosgene method cannot be used to produce simple aliphatic polycarbonate. With the development of the non-phosgene method in the 1990s, the phosgene method has been gradually eliminated, and replaced by the non-phosgene process based on diphenyl carbonate (DPC) as a carbonate source, and bisphenol A (BPA). However, the non-phosgene DPC process is complicated and should be under harsh conditions. In addition to developing a more mature DPC process, many scholars have proposed a synthetic method for more directly synthesizing polycarbonate; for example, using dimethyl carbonate (DMC) and bisphenol A to directly synthesize polycarbonate is considered to have potential of development. The advantage of the DMC process is avoiding the use of phenol, and its byproduct is methanol, which is harmless and cleaner for the environment. Thus, in view of commercial as well as environmental points, the DMC process has its value.

Asahi Kasei Chemicals Corporation proposed to proceed polymerization of a dimethyl carbonate and an aliphatic diol to synthesize polycarbonate diol with the number average molecular weight ranged from about 300 to 20,000. Polycarbonate diol can be used as a diol monomer of polyurethane and thermoplastic elastomer.

In the German Patent No. 2446107A, which described a method for producing a polycarbonate from a chloride carbonate and an aliphatic glycols, bisphenol A (BPA) and bis-chlorocarbonic acid ester were dissolved in dichloromethane, and 1,6-hexanediol was further added to a mixed solution of dichloromethane to dissolve. After 1.5 hours, 10 drops of triethylamine were added therein, then the mixture reacted at 30° C. to give an aliphatic polycarbonate. Moreover, in German Patents No. 2523352A, 2546534A, and 10027907A1, the transesterification method of polycarbonate synthesis from carbonates and aliphatic glycols are also proposed. However, the polycarbonate synthesized by above method has a lower molecular weight, the weight average molecular weight (Mw) thereof is ranged from 15,000 to 20,000 g/mole. In addition, bisphenol A is an environmental hormone which has adverse effects on humans and the environment.

Therefore, it is necessary to provide a copolymer based on dimethyl carbonate and a method of preparing the copolymer using a green monomer as a raw material and a green process to solve the problems existing in the conventional technology, as described above.

### SUMMARY OF THE INVENTION

A primary object of the present invention is to provide a copolymer based on dimethyl carbonate and a method of preparing the same. A green monomer is used as a raw material, and a non-phosgene process is carried out to produce a polycarbonate which is friendly towards the environment, has low environmental pollution, low toxicity, good biocompatibility, and high stability. The method is different from the traditional PC process, which may cause accident due to phosgene leakage, and improves environmental pollution so that the possibility of industrial mass production is greatly increased. In addition, different aliphatic ester monomers are introduced to form the copolymer to enhance not only weather resistance and hydrolysis resistance, but also the processing applications of the polycarbonates in subsequent processes and industrial applications.

To achieve the above object, the present invention provides a copolymer based on dimethyl carbonate having the structure given in the following formula (I):

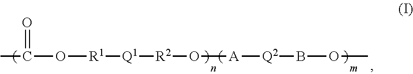

wherein A is selected from

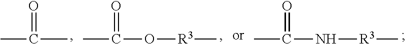

B is selected from R4,

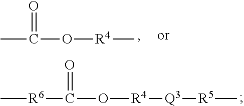

R¹, R², R³, R⁴, R⁵ and R⁶ are independently selected from a C₁-C₁₂ alkylene group or a C₁-C₁₂ hydrocarbon group; Q¹ and Q³ are independently selected from a monocyclic C₃-C₂₀ cycloalkylene group, a polycyclic C₃-C₂₀ cycloalkylene group, or a C₁-C₂₀ alkylene group; Q² is selected from a monocyclic C₃-C₂₀ cycloalkylene group, a polycyclic C₃-C₂₀ cycloalkylene group, a C₁-C₂₀ alkylene group, a monocyclic C₃-C₂₀ cycloalkylene group containing at least one double bond, a polycyclic C₃-C₂₀ cycloalkylene group containing at least one double bond, or a C₁-C₂₀ alkylene group containing at least one double bond; and 0.05≤m≤m≤0.95, 0.05≤n≤0.95, wherein m+n=1.

In one embodiment of the present invention, A is

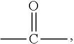

### and B is

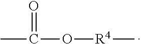

In one embodiment of the present invention, R¹, R², R⁴ and R⁵ are methylene groups (—CH₂—), Q¹ is

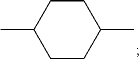

### and Q² is —HC═CH—.

In one embodiment of the present invention, A is

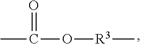

### and B is R⁴.

In one embodiment of the present invention, A is

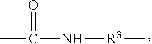

### and B is

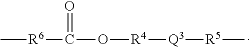

In one embodiment of the present invention, a weight average molecular weight (Mw) of the copolymer based on dimethyl carbonate is more than 20,000 g/mole.

In one embodiment of the present invention, the weight average molecular weight is ranged from 20,000 g/mole to 70,000 g/mole.

Furthermore, the present invention provides a method of preparing the abovementioned copolymer based on dimethyl carbonate, comprising the steps of (1) proceeding a transesterification reaction of a dimethyl carbonate and a diol to form a polymerizable precursor; and (2) proceeding a polycondensation reaction of the polymerizable precursor and a modification monomer to form the copolymer.

In one embodiment of the present invention, the diol having the structure given in the following formula (II):

HO—X-Q-Y—OH (II),

Q is the same as Q¹ in formula (I), and when X is the same as one of R¹ and R², Y corresponds to the other one of R¹ and R².

In one embodiment of the present invention, the molar ratio of the dimethyl carbonate, the diol and the modification monomer is 3.5˜4.5:3.5˜4.5:3˜1.

In one embodiment of the present invention, the modification monomer is selected from a dioic acid, an anhydride, a diol, a diamine, or a lactam.

In one embodiment of the present invention, the anhydride is maleic anhydride.

In one embodiment of the present invention, the lactam is caprolatam.

In one embodiment of the present invention, the step (1) is carried out at a temperature ranged from 150° C. to 180° C.

In one embodiment of the present invention, the polymerizable precursor has a weight average molecular weight ranged from 2,000 g/mole to 5,000 g/mole.

In one embodiment of the present invention, step (2) is carried out at a temperature ranged from 180° C. to 200° C., and in a vacuum ranged from 1 torr to 3 torr.

### DESCRIPTION OF THE DRAWINGS

FIGS. 1a-1b show the stress-strain curves of polycarbonate (PC) and a copolymer of polycarbonate-maleic anhydride (PC-MA) prepared in one embodiment of the present invention. FIG. 1a: stress-strain curve of PC; FIG. 1b: stress-strain curve of PC-MA (“-” represents PC-MA10%; “----” represents PC-MA20%)

FIGS. 2a-2b show the stress-strain curves of polycarbonate (PC) and a copolymer of polycarbonate-caprolactam (PC-CPL) prepared in one embodiment of the present invention. FIG. 2a: stress-strain curve of PC; FIG. 2b: stress-strain curve of PC-CPL (“-” represents PC-CPL10%; “----” represents PC-CPL20%; “---” represents PC-CPL30%)

### DETAILED DESCRIPTION OF THE PREFERRED EMBODIMENTS

The structure and the technical means adopted by the present invention to achieve the above and other objects can be best understood by referring to the following detailed description of the preferred embodiments and the accompanying drawings. Furthermore, if there is no specific description in the invention, singular terms such as “a”, “one”, and “the” include the plural number. For example, “a compound” or “at least one compound” may include a plurality of compounds, and the mixtures thereof. If there is no specific description in the invention, the “%” means “weight percent (wt %)”, and the numerical range (e.g. 10%-11% of A) contains the upper and lower limit (i.e. 10%≤A≤11%). If the lower limit is not defined in the range (e.g. less than, or below 0.2% of B), it means that the lower limit is 0 (i.e. 0%≤B≤0.2%). The proportion of “weight percent” of each component can be replaced by the proportion of “weight portion” thereof. The abovementioned terms are used to describe and understand the present invention, but the present invention is not limited thereto.

A copolymer based on dimethyl carbonate according to a preferred embodiment of the present invention is provided, and has the structure given in the following formula (I):

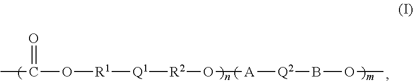

wherein A is selected from

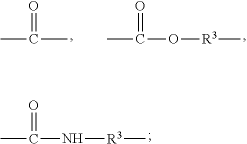

B is selected from R⁴,

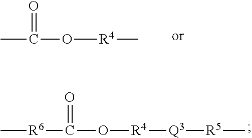

R¹, R², R³, R⁴, R⁵ and R⁶ are independently selected from a C₁₋₁₂ alkylene group or a C₁₋₁₂ hydrocarbon group; Q¹ and Q³ are independently selected from a monocyclic C₃₋₂₀ cycloalkylene group, a polycyclic C₃-C₂₀ cycloalkylene group, or a C₁-C₂₀ alkylene group; Q² is selected from a monocyclic C₃-C₂₀ cycloalkylene group, a polycyclic C₃-C₂₀ cycloalkylene group, a C₁-C₂₀ alkylene group, a monocyclic C₃-C₂₀ cycloalkylene group containing at least one double bond, a polycyclic C₃-C₂₀ cycloalkylene group containing at least one double bond, or a C₁-C₂₀ alkylene group containing at least one double bond; and 0.05≤m≤0.95, 0.05≤n≤0.95, wherein m+n=1. In the formula (I), when A is

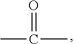

### B is

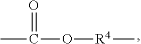

wherein R¹, R², R⁴ and R⁵ are methylene groups (—CH₂—), Q¹ is

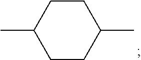

### and Q² is —HC═CH—.

Moreover, when A is

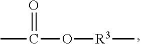

### B is R⁴. When A is

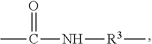

### B is

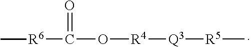

In one embodiment of the present invention, a weight average molecular weight (Mw) of the copolymer based on dimethyl carbonate is more than 20,000 g/mole, preferably ranged from 20,000 g/mole to 70,000 g/mole.

Furthermore, a method of preparing the abovementioned copolymer based on dimethyl carbonate according to a preferred embodiment of the present invention is provided, and comprises the steps of (S1) proceeding a transesterification reaction of a dimethyl carbonate and a diol to form a polymerizable precursor; and (S2) proceeding a polycondensation reaction of the polymerizable precursor and a modification monomer to form the copolymer as mentioned above. The principle and the implementation details of each step in this embodiment of the present invention will be described in detail hereinafter.

First, the method of preparing the abovementioned copolymer based on dimethyl carbonate according to a preferred embodiment of the present invention is the step (1): proceeding a transesterification reaction of a dimethyl carbonate and a diol to form a polymerizable precursor. The diol has the structure given in the following formula (II):

HO—X-Q-Y—OH (II),

wherein Q is the same as Q¹ in formula (I), and when X is the same as one of R¹ and R², Y corresponds to the other one of R¹ and R². In this step, the transesterification reaction is carried out at a temperature ranged from 150° C. to 180° C. In addition, the polymerizable precursor has a Mw ranged from 2,000 g/mole to 5,000 g/mole.

Next, the method of preparing the abovementioned copolymer based on dimethyl carbonate according to a preferred embodiment of the present invention is the step (S2): proceeding a polycondensation reaction of the polymerizable precursor and a modification monomer to form the copolymer as mentioned above. In this step, the polycondensation reaction is carried out at a temperature ranged from 180° C. to 200° C., and in a vacuum ranged from 1 torr to 3 torr. Besides, the molar ratio of the dimethyl carbonate, the diol and the modification monomer is 3.5˜4.5:3.5˜45: 3˜1, for example 4:4:2 or 4.2:4.2:1.6, but it is not limited thereto. The modification monomer is selected from a dioic acid, an anhydride, a diol, a diamine, or a lactam. When the modification is a dioic acid, an anhydride, or a diol, it preferably contains at least one unsaturated carbon to carbon bonding. The anhydride with an unsaturated double bond is, for example, maleic anhydride. The dioic acid with an unsaturated double bond is, for example, butenedioic acid. In addition, the modification monomer is, for example, the diamine or the lactam without an unsaturated carbon to carbon bonding. The lactam is caprolatam.

To make the copolymer and the method for preparing the copolymer of the present invention more definite, please refer to the actual manufacturing process described in the following.

In an example of the present invention, dimethyl carbonate

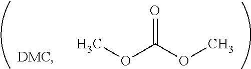

and 1,4-cyclohexanedimethanol

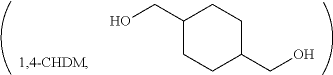

are used for synthesizing polycarbonate, and then a modification monomer such as maleic anhydride

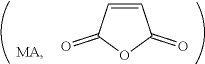

or caprolactam

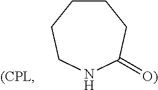

is introduced to synthesize a copolymer. Optionally, maleic anhydride or caprolactam can be modified for certain purposes, such as its reactivity, or solubility, but they are not limited thereto. The reaction process can be divided into two phases, the first phase is a transesterification reaction, and the second phase is a polycondensation reaction. The proportions of each component used in the reactions are shown in Table 1.

TABLE 1

| | | | | Modification |
|---|---|---|---|---|
| | | | | monomer |
| | | | | calculated by |
| | | | Modification | NMR |
| | DMC | 1,4-CHDM | monomer | (based on total) |
| PC | 100 | 100 | — | — |
| PC-MA(10%) | 90 mole % | 90 mole % | 20 mole % MA | 8 mole % |
| PC-MA(20%) | 80 mole % | 80 mole % | 40 mole % MA | 19 mole % |
| PC-CPL(10%) | 90 mole % | 90 mole % | 20 mole % CPL | 9 mole % |
| PC-CPL(20%) | 80 mole % | 80 mole % | 40 mole % CPL | 18 mole % |
| PC-CPL(30%) | 70 mole % | 70 mole % | 60 mole % CPL | 30 mole % |

First, the reaction of DMC and 1,4-CHDM in the first phase is mainly to form a polymerizable precursor. During the reaction, the pressure is controlled, and the by-produced methanol is continuously removed for maintaining the forward reaction. In this embodiment, the preparation pressure of the system is 5.5 bar, the reaction temperature is ranged from about 140° C. to 160° C. The temperature is raised by 10° C. per 10 minutes until the temperature of transesterification reaction is in the range of 150° C. to 180° C., and the reaction extent is determined by the yield of the secondary production when it reaches about 80% of the theoretical value to obtain a polyester prepolymer (i.e. the polymerizable precursor). Then, the next phase can be carried out.

The second phase is the polycondensation reaction carried out at a high temperature and in a high vacuum environment, the prepolymer obtained from the transesterification reaction in the first phase is applied thereto, at a temperature of 180-200° C., in a vacuum of 1 torr to 3 torr, the temperature is raised by 5° C. per 30 minutes up to the polymerization temperature. The DMC is continuously removed for ensuring the forward reaction to synthesize an aliphatic polycarbonate. Until a stable torque value is reached, a copolymer containing dimethyl carbonate units is obtained.

In the case of the copolymer produced by maleic anhydride, the maleic anhydride is modified by glycol before performing the polycondensation reaction in the second phase, the copolymer has the structure given in the following formula (III):

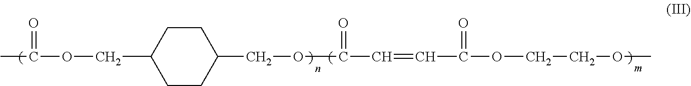

The unsaturated carbon to carbon double bond is introduced by MA as a bridging point for further processing in order to expand its industrial applicability.

Furthermore, the copolymer produced by caprolactam has the structure given in the following formula (IV):

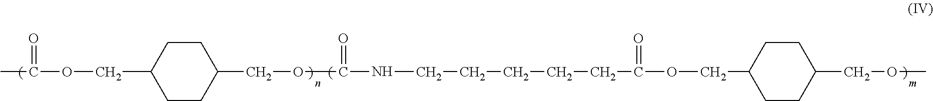

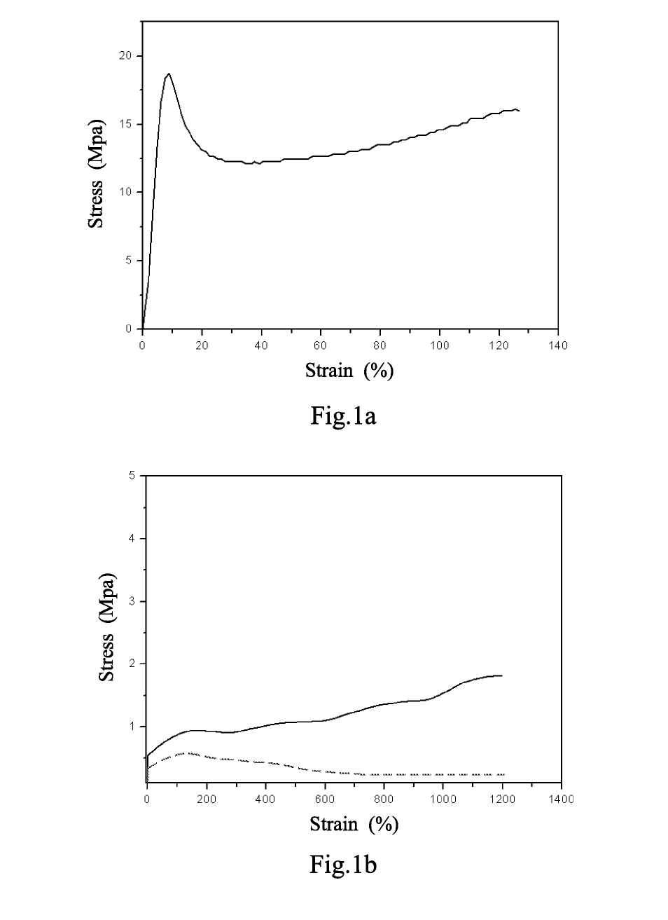

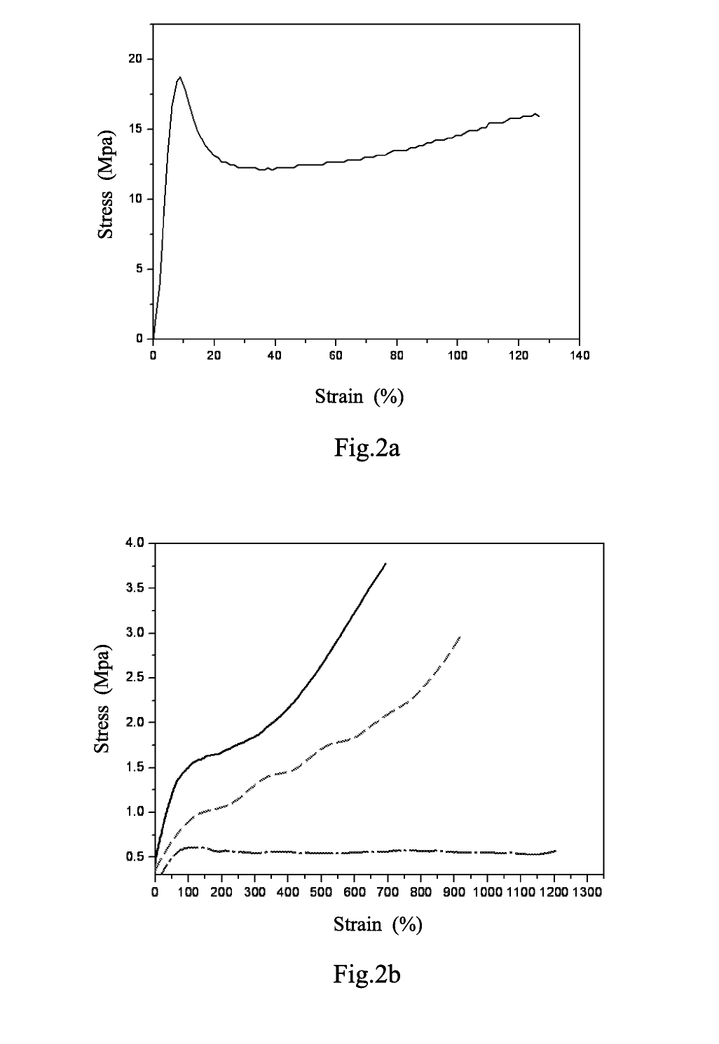

Please refer to FIGS. 1a-1b and FIGS. 2a-2b, which are the stress-strain curves of PC, PC-MA, and PC-CPL. From FIGS. 1a and 1b, the stress-strain curve of polycarbonate (PC) shows a characteristic of a polymer with an elongation of 126%. After introducing maleic anhydride, elongation is greatly improved due to a soft segment of the double bond, and the stress-strain curve shows a graph of rubber-like elastomer. Furthermore, it can be seen from FIGS. 2a and 2b that the elongation can be increase by increasing the added ratio of CPL. The pure PC has 126% elongation, and the elongation of the copolymer PC-CPL is greatly increased by introducing CPL to PC. Because the original six-membered ring which gives rigidity to PC is broken, the stress-strain curve shows a graph of rubber-like elastomer. Since polycarbonate itself is good hydrolysis resistance, the introduced CPL does not affect the superior hydrolysis resistance by gel permeation chromatography (GPC).

Referring to Table 2, pure PC is a non-crystalline material with a glass transition temperature (T_{g}) of about 40° C. In addition, the glass transition temperature and the thermal decomposition temperature (Td, 5 wt %) of PC copolymer is gradually decreased with the added amount of of MA, or CPL by 10%, 20%, 30%.

TABLE 2

| | Mw | T_{g}(° C.) | Td⁵(° C.) |
|---|---|---|---|
| PC | 28000 | 40 | 332 |
| PCMA(10%) | 24900 | 25 | 317 |
| PCMA(20%) | 26100 | 15 | 308 |
| PCCPL(10%) | 36000 | 22 | 333 |
| PCCPL(20%) | 48900 | 14 | 317 |
| PCCPL(30%) | 65200 | 8 | 306 |

Furthermore, the present invention provides a method for directly synthesizing aliphatic polycarbonate with DMC and different ratios of diol to control the molecular weight of the polycarbonate diol used for other polymerizations. Referring to the following Table 3, in the example of DMC and 1,4-butanediol (BD), the aliphatic polycarbonate diol can be efficiently synthesized with a molar weight of about 2,000 to 5,000 by controlling the monomer ratio, reaction temperature, etc.

TABLE 3

| | | | | | |
|---|---|---|---|---|---|
| DMC/BD | 1 | 0.94 | 0.90. | 0.85 | 0.75 |
| Mn | 4884 | 2845 | 2800 | 2200 | 2032 |

Compared with conventional techniques, in accordance with the copolymer and the method of preparing the copolymer based on dimethyl carbonate, the copolymer has excellent heat resistance, toughness, and good dimensional stability of the aliphatic polycarbonate via polycondensation reaction. Because a green monomer is used as raw material, and environmentally harmful substances are not produced during the process, the copolymer of polycarbonate which is environmentally friendly, and has low pollution, low toxicity, good biocompatibility, and high stability can be prepared. The possibility of industrial production is significantly raised. The prepared copolymer not only enhances the weather resistance and hydrolysis resistance of PC, but also increases processing applications and industrial applications of the polycarbonates in subsequent processes.

The present invention has been described with preferred embodiments thereof and it is understood that many changes and modifications to the described embodiments can be carried out without departing from the scope and the spirit of the invention that is intended to be limited only by the appended claims.

What is claimed is:

1. A copolymer based on dimethyl carbonate having the structure given in the following formula (I): 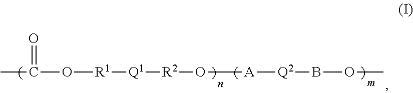
wherein A is selected from 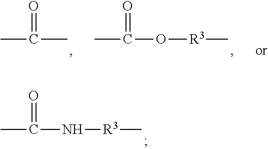
B is selected from R⁴, 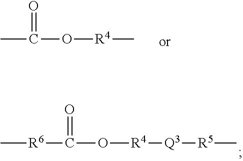
R¹, R², R³, R⁴, R⁵ and R⁶ are independently selected from a C₁-C₁₂ alkylene group or a C₁-C₁₂ hydrocarbon group; Q¹ and Q³ are independently selected from a monocyclic C₃-C₂₀ cycloalkylene group, a polycyclic C₃-C₂₀ cycloalkylene group, or a C₁-C₂₀ alkylene group; Q² is selected from a monocyclic C₃-C₂₀ cycloalkylene group, a polycyclic C₃-C₂₀ cycloalkylene group, a C₁-C₂₀ alkylene group, a monocyclic C₃-C₂₀ cycloalkylene group containing at least one double bond, a polycyclic C₃-C₂₀ cycloalkylene group containing at least one double bond, or a C₁-C₂₀ alkylene group containing at least one double bond; and 0.05≤m≤0.95, 0.05≤n≤0.95, wherein m+n=1.

2. The copolymer based on dimethyl carbonate according to claim 1, wherein A is 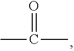
and B is

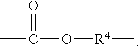

3. The copolymer based on dimethyl carbonate according to claim 2, wherein R¹, R², R⁴ and R⁵ are methylene groups (—CH₂—), Q¹ is 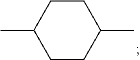
and Q² is —HC═CH—.

4. The copolymer based on dimethyl carbonate according to claim 1, wherein A is 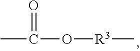
and B is R⁴.

5. The copolymer based on dimethyl carbonate according to claim 1, wherein A is 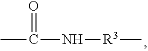
and B is

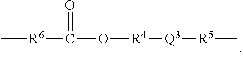

6. The copolymer based on dimethyl carbonate according to claim 1, wherein a weight average molecular weight (Mw) of the copolymer based on dimethyl carbonate is more than 20,000 g/mole.

7. The copolymer based on dimethyl carbonate according to claim 6, wherein the weight average molecular weight is ranged from 20,000 g/mole to 70,000 g/mole.

8. A method of preparing the copolymer based on dimethyl carbonate according to claim 1, comprising the following steps:
(1) proceeding a transesterification reaction of a dimethyl carbonate and a diol to form a polymerizable precursor; and
(2) proceeding a polycondensation reaction of the polymerizable precursor and a modification monomer to form the copolymer based on dimethyl carbonate in a vacuum ranged from 1 torr to 3 torr at a temperature ranged from 180° C. to 200° C., wherein the modification monomer is selected from a dioic acid with at least one unsaturated carbon to carbon bonding, an anhydride with at least one unsaturated carbon to carbon bonding, a diol with at least one unsaturated carbon to carbon bonding, or a lactam;
wherein the copolymer based on dimethyl carbonate has a structure given in the following formula (I): 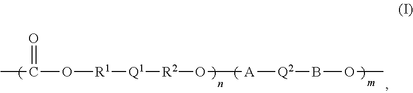
wherein A is selected from 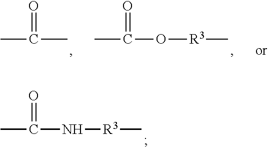
B is selected from R⁴, 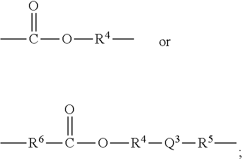
R¹, R², R³, R⁴, R⁵ and R⁶ are independently selected from a C₁-C₁₂ alkylene group or a C₁-C₁₂ hydrocarbon group; Q¹ and Q³ are independently selected from a monocyclic C₃-C₂₀ cycloalkylene group, a polycyclic C₃-C₂₀ cycloalkylene group, or a C₁-C₂₀ alkylene group; Q² is selected from a monocyclic C₃-C₂₀ cycloalkylene group, a polycyclic C₃-C₂₀ cycloalkylene group, a monocyclic C₃-C₂₀ cycloalkylene group containing at least one double bond, a polycyclic C₃-C₂₀ cycloalkylene group containing at least one double bond, or a C₁-C₂₀ alkylene group containing at least one double bond; and 0.05≤m≤0.95, 0.05≤n≤0.95, wherein m+n=1.

9. The method according to claim 8, wherein the diol in the step (1) has the structure given in the following formula (II):
HO—X-Q-Y—OH (II),
Q is the same as Q1 in formula (I), and when X is the same as one of R¹ and R², Y corresponds to the other one of R¹ and R².

10. The method according to claim 8, wherein the molar ratio of the dimethyl carbonate, the diol, and the modification monomer is 3.5˜4.5:3.5˜45:3˜1.

11. The method according to claim 8, wherein the anhydride is maleic anhydride.

12. The method according to claim 8, wherein the lactam is caprolatam.

13. The method according to claim 8, wherein step (1) is carried out at a temperature ranged from 150° C. to 180° C.

14. The method according to claim 8, wherein the polymerizable precursor has a weight average molecular weight ranged from 2,000 g/mole to 5,000 g/mole.
